(19) United States
(12) Patent Application Publication
(10) Pub. No.: US 2024/0165523 A1
(43) Pub. Date: May 23, 2024

(54) MONOCOQUE PASSENGER CABIN FOR AMUSEMENT RIDES

(71) Applicant: Composite Energy Technologies, Inc., Bristol, RI (US)

(72) Inventors: Chase C. Hogoboom, Bristol, RI (US); Eric P. Goetz, Bristol, RI (US); Thomas J. Perrotti, Bristol, RI (US)

(21) Appl. No.: 18/516,726

(22) Filed: Nov. 21, 2023

Related U.S. Application Data
(60) Provisional application No. 63/427,364, filed on Nov. 22, 2022.

(51) Int. Cl. A63G 21/12

(52) U.S. Cl. CPC A63G 21/12; B33Y 80/00

(57) ABSTRACT

Disclosed embodiments include a monocoque passenger cabin for an amusement ride device. The cabin includes a monocoque body. The monocoque body includes a wall, a floor, and a first seat portion. The wall and the first seat portion each extend from and are integral to the floor. The wall can include an opening configured to allow passengers to enter and exit the cabin. The cabin can further include a second seat portion.

### CROSS-REFERENCE TO RELATED APPLICATION

This application claims priority to U.S. Provisional Patent Application No. 63/427,364, filed Nov. 22, 2022, the disclosure of which is incorporated into this document by reference in its entirety.

### BACKGROUND

The present disclosure generally relates to passenger cabins including amusement-ride passenger cabins. Various theme parks, carnivals, and the like offer amusement rides that move riders in various ways. While the style and intensity of such rides can vary greatly, the conventional cabin design for such rides is heavy and inefficient. For example, known conventional designs rely on the floor (or deck) of the cabin for structural support. The decks are robustly constructed and provide much of the structural support for the ride cabin, and other components of the ride are attached to the floor.

This patent document describes a device (which can be understood to also disclose a system, apparatus, method, or feature) that addresses at least some of the issues described above and/or other issues.

### SUMMARY

The disclosed technology relates to monocoque passenger cabins. In accordance with disclosed embodiments a monocoque passenger cabin for an amusement device can be provided, wherein the monocoque passenger cabin comprises: a wall, a floor, and a first seat portion. The wall and the first seat portion can each extend from and be integral to the floor. The monocoque passenger cabin is a one-piece structural shell made of fiber reinforced sheet. In some embodiments, the fiber reinforced sheet can be a composite sandwich made of polymer skins reinforced by carbon fiber. In some embodiments, the fiber reinforced sheet can be a polymer reinforced by carbon fiber or a fiber (e.g., carbon fiber) reinforced multilayer epoxy bound sheet on either side of a structural core (e.g., foam or honeycomb). The cabin is adapted to be a passenger compartment as part of an electromechanical system implemented to provide an amusement ride for general consumptions and use by the public. The ride can have many cabins and the cabins can be identical or similar.

The wall of the cabin can include an opening configured to allow passengers to enter and exit the cabin. In some embodiments, the cabin can include a second seat portion. The first and second seat portions can be arranged facing the same direction. In other embodiments, the first and second seat portions can be arranged facing the opposite direction. For example, the first and second seat portions can be arranged to face each other or be arranged to face away from each other. In some embodiments, the cabin further includes a third seat portion. The first, second, and third seat portions can be arranged in a row.

In some embodiments, the floor can include a plurality of levels. The first seat portion can be positioned on a first level of the plurality of levels, and the second seat portion can be positioned on a second level of the plurality of levels. The first level can be lower than the second level.

In further embodiments, the cabin can further include an aisle configured to permit movement by one or more passengers within the cabin. The wall can include an opening configured to allow passengers to enter and exit the cabin, and the opening can be positioned on a portion of the wall adjacent to the aisle.

The floor, wall, and seat portion can be integrally constructed as a one-piece structural shell made of fiber reinforced sheet. The fiber reinforced sheet can include at least one of: one or more polymer skins reinforced with carbon fiber, or a fiber reinforced multilayer epoxy bound sheet. The fiber reinforced sheet can further include a foam or honeycomb core. In some embodiments, the cabin can be constructed at least partially using a three-dimensional printing process. In some embodiments, a bottom portion of the floor can be configured to attach to a motion platform.

### DRAWINGS

The accompanying drawings, which are incorporated herein and constitute part of this specification, are illustrative of particular embodiments of the present disclosure and do not limit the scope of the present disclosure. The drawings are not to scale and are intended for use in conjunction with the explanations in the following detailed description.

FIG. 1 is a diagram of a perspective view of an embodiment of an illustrative passenger cabin of an amusement ride in accordance with an embodiment of the presentation invention.

FIG. 2 is a different perspective view of the embodiment of a passenger cabin of FIG. 1.

FIG. 3 is a diagram of a top view of the embodiment of a passenger cabin of FIG. 1.

FIG. 4 is a diagram of a front view of the embodiment of a passenger cabin of FIG. 1.

FIG. 5 is a diagram of a bottom view of the embodiment of a passenger cabin of FIG. 1.

FIG. 6 is a diagram of a perspective view of another embodiment of an illustrative passenger cabin of an amusement ride in accordance with an embodiment of the presentation invention.

### DESCRIPTION

The following discussion omits or only briefly describes conventional features of the disclosed technology that are apparent to those skilled in the art. Reference to various embodiments does not limit the scope of the claims attached hereto. Additionally, any examples set forth in this specification are intended to be non-limiting and merely set forth some of the many possible embodiments for the appended claims. Further, particular features described herein can be used in combination with other described features in each of the various possible combinations and permutations. A person of ordinary skill in the art would know how to use the device, in combination with routine experiments, to achieve other outcomes not specifically disclosed in the examples or the embodiments.

Unless otherwise specifically defined herein, all terms are to be given their broadest possible interpretation including meanings implied from the specification as well as meanings understood by those skilled in the art and/or as defined in dictionaries, treatises, etc. Unless defined otherwise, all technical and scientific terms used herein have the same meaning as commonly understood by one of ordinary skill in the art in the field of the disclosed technology. It must also be noted that, as used in the specification and the appended claims, the singular forms “a,” “an” and “the” include plural referents unless otherwise specified, and that the terms “includes” and/or “including,” when used in this specification, specify the presence of stated features, elements, and/or components, but do not preclude the presence or addition of one or more other features, steps, operations, elements, components, and/or groups thereof. Additionally, methods, equipment, and materials similar or equivalent to those described herein can also be used in the practice or testing of the disclosed technology.

The devices of the present disclosure may be understood more readily by reference to the following detailed description of the embodiments taken in connection with the accompanying drawing figures, which form a part of this disclosure. It is to be understood that this application is not limited to the specific devices, methods, conditions or parameters described and/or shown herein, and that the terminology used herein is for the purpose of describing particular embodiments by way of example only and is not intended to be limiting. Reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It is also understood that all spatial references, such as, for example, proximal, distal, horizontal, vertical, top, upper, lower, bottom, left and right, are for illustrative purposes only and can be varied within the scope of the disclosure. For example, the references “upper” and “lower” are relative and used only in the context to the other, and are not necessarily “superior” and “inferior”. The words “can” or “may” are used to communicate that this is one embodiment but others are contemplated.

Various examples of the disclosed technology are provided throughout this disclosure. The use of these examples is illustrative only, and in no way limits the scope and meaning of the invention or of any exemplified form. Likewise, the invention is not limited to any particular preferred embodiments described herein. Indeed, modifications and variations may be apparent to those skilled in the art upon reading this specification, and can be made without departing from its spirit and scope.

The present application relates to monocoque cabin structure design. For example, in some embodiments, an (aggressively) lightweight cabin enclosure can be provided inclusive of structure required to safely support the passengers of the cabin and robustly mount the cabin to a motion control mechanism.

Known conventional passenger cabins have incorporated a heavily reinforced cabin floor that serves as the backbone for overall vehicle load transfer and distribution. Other major components of the passenger cabin (side panels, partition walls, seats, walk platforms, etc.) are typically not considered in the design implementation of the global vehicle support structure, and inherently “go along for the ride”, while the cabin floor itself is tasked to handle and manage the dominant ride forces, accelerations, and loads.

Embodiments of the present invention can significantly increase the strength of a passenger cabin for a given weight, while providing for all of the ergonomics and passenger safety features that go hand-in-hand with standard ride vehicle requirements. This can be achieved through a monocoque, structural cabin design as illustratively described herein. Cabin components that normally exist above the cabin floor are integrated into the vehicle's global structure.

In such an integrated monocoque structure, seats, guest partitions, roof, and cabin enclosure walls can each serve double-duty function: not only can they server their baseline role, but also as box-beam structure (of substantial height and strength) working together in harmony with the passenger cabin's global structure. The integration of these components into the whole structure of the cabin can cause the monocoque cabin structure to act effectively as an I-beam. I-beams work well because they carry loads and stresses in mated flanges that are separated by (but integrally attached to) a shear web. Bending loads distributed into an I-beam put one flange in tension and the other flange in compression. For a given material, the strength of an I-beam is proportional to the mathematical square of the I-beam's height (or distance between flanges). As an example, if an I-beam's height is doubled, its strength is quadrupled. In other words, a 6-inch tall I-beam is four-times as strong as a 3-inch tall I-beam. The monocoque ride cabin structure disclosed herein can act as an effective beam, with the height of the cabin components (16″ for a seat base; 35″ for a seat back, 55″ for cabin sidewalls) offering a large magnitude of strength increase when compared to a traditional 3 inch thick structural cabin floor.

Disclosed embodiments can improve the strength of a passenger cabin and achieve conservative and reliable factors of safety while also decreasing the overall weight of the passenger cabin. Referring back to the incorporated I-beam structure, as a beam's height is increased, the thickness of the beam's flanges can be reduced to result in a beam of the same strength—this can yield substantial weight savings for equivalent beam strength. In other words, an optimized taller beam is a lighter beam. Thus, a monocoque cabin structure (with structurally integrated seats, partitions, cabin walls, and the like) offers the key to packaging the passenger cabin into acceptable and reliable high-strength and light-weight targets.

The cabin structure can include an incorporated integral I-beam-like structure. In other words, various features (floor, seats, walls, etc.) of the cabin can be constructed such that, under load, opposing outer surfaces are placed tension or compression, while material within the body (between the outer surfaces) acts as a shear web. The compressive and tensile forces can be opposite on the opposing surfaces of the cabin, depending on the forces the cabin is experiencing. Accordingly, because of the monocoque design the cabin can be configured to distribute stresses (placed on it by riders, by the motion of the cabin, etc.) across all or a majority of the cabin structure. In some embodiments, the cabin can include one or more internal ribs or similar features within the body that stiffen the body. Such ribs or similar features are integral to the body and can act as I-beam shear webs to further distribute load. In some embodiments, the bottom of the body may not be solid, but can be open and include visible ribs along with one or more attachments points for a ride motion platform, as described in further detail below.

The use of carbon fiber plays a role in the disclosed monocoque design and construction. For comparable strength, carbon fiber is about 86% lighter than structural steel, about 75% lighter than aluminum, and about 65% lighter than traditional fiberglass. The disclosed carbon fiber build methods can integrate and bond together various carbon fiber components and modules into a cohesive, fully optimized global structure.

The present disclosure relates to an amusement-ride passenger cabin having a monocoque construction. There are many applications of passenger cabins in amusement rides or attractions. The passenger cabins are part of an integrated system with a motion platform in which the dynamic physical movement of the ride, weight of passengers, performance, safety, comfort, and range of operational stresses are together designed to produce a ride (in general in this context meaning the electromechanical elements of the motion platform that together when installed provide for an amusement ride) for general public use. As used herein, a monocoque refers to a structural shell or exoskeleton in which the vehicle's structural frame and outer skins are built as an integrated structure.

Accordingly, the passenger cabin can have a monocoque body that forms an integral shell and support structure for the cabin. An interior area of the monocoque body can implement passenger seating (or other form of passenger occupancy).

Conventional amusement ride passenger cabins typically include a deck portion that is adapted to provide the structural support for the cabin passengers and related physical forces experienced by the ride when operating the amusement ride. Other portions of conventional cabins provide other functions and have no or very little contribution to the structural support provided by the cabin to the load in operation (meaning operation it is designed for). Such designs are very heavy and dense, thus presenting limitations with size, speed, safety, acceleration, and passenger carrying capacity. This includes known ride designs that incorporate FRP (fiber reinforced polymer) or carbon fiber skin(s) into the cabin or support structure. The disclosed technology implementing a monocoque body addresses these and other problems by providing a lighter and stronger passenger cabin. Thus, the monocoque body can facilitate relative increases in size, speed, safety, acceleration, passenger carrying capacity, etc. In some implementations, by varying the thickness or the material of the monocoque body and positioning, the center of gravity is moved to provide certain performance capabilities.

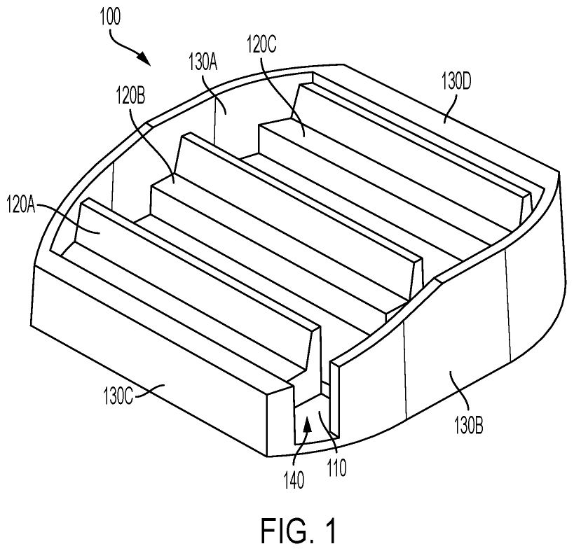

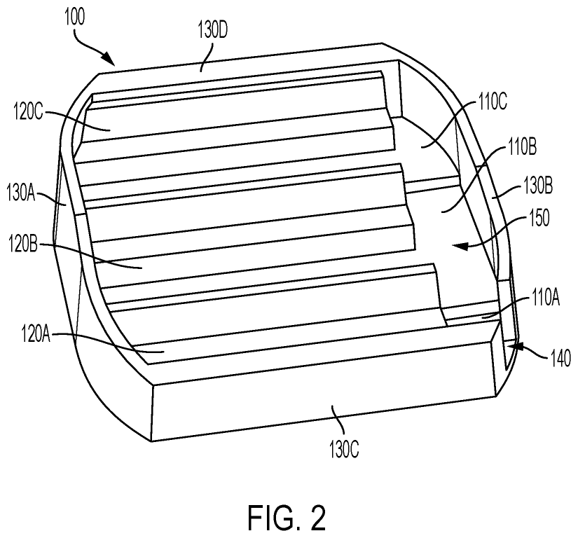

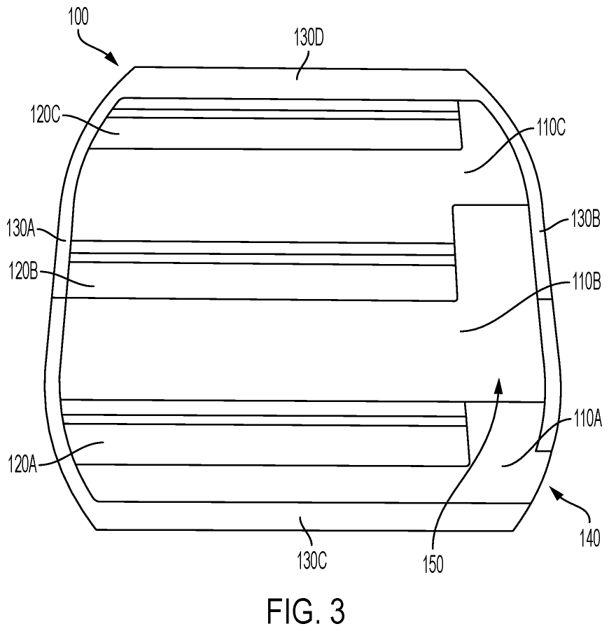

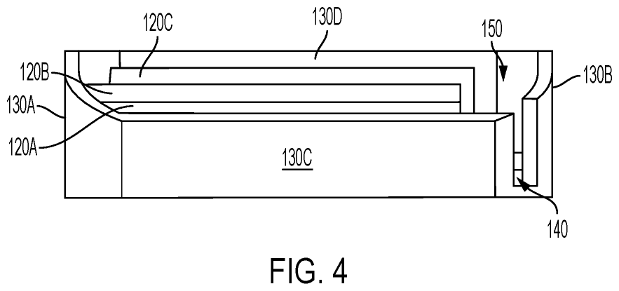

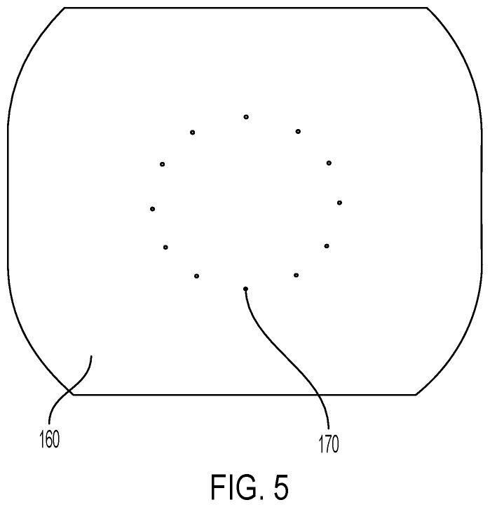

FIGS. 1-5 illustrate an embodiment of a passenger cabin 100. FIG. 1 is a top, front, left side perspective view of cabin 100. FIG. 2 is a top, front perspective view of cabin 100. FIG. 3 is a top view of cabin 100. FIG. 4 is a front view of cabin 100. FIG. 5 is a bottom view of cabin 100.

Cabin 100 can have a floor 110, one or more seats 120A-C, and one or more side walls 130A-D. The floor 110, seats 120A-C, and walls 130A-D can all be portions of an integral whole forming the body (i.e., a monocoque body) of cabin 100. Cabin 100 can further include an opening or door 140. Opening 140 can lead to an aisle 150 on one side of the cabin 100 to allow passengers to enter and sit in the passenger seating in the cabin. In other words, opening 140 can be positioned on a portion of a wall 130A-D adjacent to aisle 150 (e.g., on wall 130B as shown in the figures).

The illustrated cabin 100 has a monocoque body. The monocoque body is constructed as a one-piece structural shell. The structural shell can be an outside shell forming the exterior of the cabin. A fiber reinforced polymer bound sheet material (for example, a polymer epoxy reinforced by carbon fiber) may be used for the monocoque body. As used herein, fiber reinforced polymer bound sheet material may refer to a cured structural epoxy and fiber matrix. The monocoque body may be constructed by layering fiber reinforced polymer and forming it into the shape of the cabin. Various materials can be used for construction of the monocoque body, and the materials can have various relative strengths and relative weights. In some embodiments, multiple materials may be combined into a single laminate to achieve a desired strength to weight ratio. Three-dimensional printing systems can be used in producing the cabin.

While passenger cabin 100 is depicted in the figures as having certain proportions and features, other shapes and proportions are possible. For example, the cabin may be relatively longer or wider as compared to its illustrated dimensions. As other examples, cabin 100 can include more or fewer seating rows, an aisle or opening in a different location (such as an aisle on both sides and/or in the middle of cabin 100), taller or shorter walls or seats, curved or rounded edges. Additionally, cabin 100 can take a variety of shapes as viewed from the top. For example, as depicted in FIG. 3, cabin 100 can be substantially rectangular with rounded corners, but other shapes are possible.

As shown in the figures, cabin 100 is adapted to receive passengers that are seated in the cabin during the operation of the ride. The number of passengers can vary based on the type of ride or other factors. Cabin 100 as shown includes a floor 110 and walls 130A-D that surround the area that is adapted to receive the passengers. Specifically, cabin 100 can include right side wall 130A, left side wall 130B, front wall 130C and rear wall 130D. A gate or opening 140 is formed in the structure (e.g., in one or more of the walls 130A-D) to allow passengers to enter the cabin and move along the aisle 150 to be seated. The walls 130A-D can provide an obstruction to prevent passengers or items from falling from the ride (but also provide structural support, as discussed, for the load carried by the cabin in operation). Walls can be fully enclosed and continuous or include one or more openings or windows. In some embodiments, opening 140 can be configured to receive a door or gate to enclosed cabin 100 (e.g., when the ride is in operation).

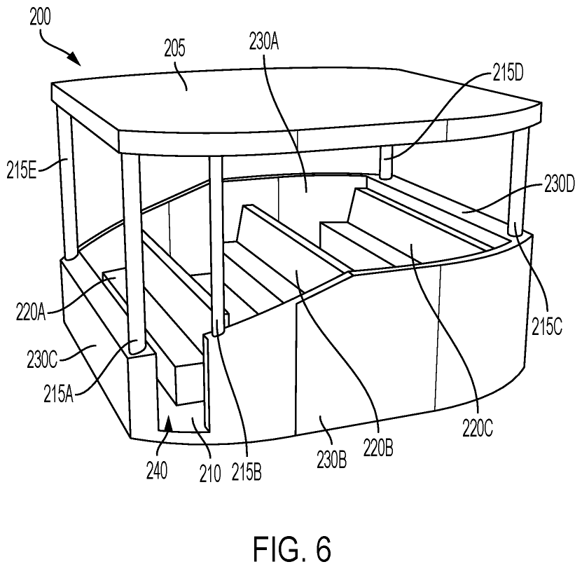

In some embodiments, cabin 100 can further include a roof. For example, as shown in FIG. 6, a passenger cabin 200 can include a roof 205. Roof 205 can be supported by beams or posts 215A-E or other supports attached to walls 230A-D. Cabin 200's components such as walls 230A-D, seats 220A-C, opening 240, and floor 210 can be substantially as described herein with respect to their corresponding components of cabin 100. In the illustrated embodiment, the roof is separated from the walls and supported by, for example, posts 215A-E extending above the walls. Thus, the cabin is be covered, but is not fully enclosed because a gap is formed between the roof 205 and walls. In some embodiments, the posts can extend from the floor 210 of the cabin. In some embodiments, the posts can be formed integrally with other portions of cabin 200. In other embodiments, the roof can be contiguous with the walls of cabin 200 to create a fully enclosed cabin. In such a case, walls 230A-D may be proportionally taller than pictured in the figures to permit passengers to easily stand within the cabin.

Referring back to FIGS. 1-5, Cabin 100 can further include one or more seats 120A-C. Seats 120A-C as shown are a portion of the monocoque body. Seats 120A-C as shown are adapted to receive seated passengers (but also provide structural support, as discussed, for the load carried by the cabin in operation). Seats 120A-C can be an area of the cabin configured to receive passengers. As shown in the figures, seats 120A-C are benches with back rests; however, other variations are possible such as benches without back rests, individual seats, stools, buckets seats, wall portions configured to receive leaning passengers, or others. Seats 120A-C can be placed in rows (e.g., one seat can be placed behind another seat). In some embodiments, seats (or rows of seats) 120A-C can be facing all in the same direction. In other embodiments, seats 120A-C may be facing in different directions. For example, seats (or rows of seats) 120A-C can be facing in opposite directions (i.e., facing one another or facing away from one another). As one specific example, seats (or rows of seats) 120A-C could be oriented parallel to side walls 130A,B and facing each other with an aisle in the middle, also parallel to side walls 130A,B. As another example, seats (or rows of seats) 120A-C could be placed in or near the center of cabin 100 and be arranged back to back (e.g., with one facing front wall 130C and one facing back wall 130D). In such a case, an aisle 150 could be present on the front and back side of the seats. Of course, many other arrangements and orientations of seats are possible, as would be understood by a person of ordinary skill in the art.

The floor portion 110, side walls 130A-D, and seats 120A-C together function to provide the structural support for the expected load of the passengers while in operation during the ride. In conventional designs, the bottom deck portion provides this function and is adapted to be heavy and rigid. In addition, the monocoque body is attached to a ride motion platform which may include wheels, rails, arms, or other structure that applies dynamic forces to the passengers via the cabin during the ride. The distribution of the structural bearing aspects of the cabin 100 by the monocoque body also supports the ride-interaction with the operation of the ride. Floor 110 can include a plurality of levels. For example, as shown in the figures, each seat 120A-C can have a corresponding level (i.e., floor portions 110A-C shown in FIGS. 2 and 3). For example, seat 120A can be positioned on floor level 110A, seat 120B can be positioned on floor level 110B, and seat 120C can be positioned on floor level 110C. In this example, floor level 110B is lower than floor level 110C, and floor level 110A is lower than floor level 110A. This creates a “stadium seating” effect and can permit, for example, better views to passengers seated in the back row (i.e., seat 120C) or otherwise behind other passengers. The plurality of levels can also increase the structural rigidity of the rear portion of cabin 100 because that portion can be thicker to accommodate the increased height of floor 110.

Cabin 100 can be attached to the motion platform. The attachment of cabin 100 to the motion platform can be achieved with fasteners (e.g., bolts, screws, pins, rivets, or other suitable fasteners), structural attachment features (e.g., one or more dovetails, tracks, wheels, or other mating features), adhesives, or other suitable attachment mechanisms or combinations thereof. FIG. 5 illustrates a bottom view of cabin 100. A bottom portion of floor 110 (e.g., bottom 170) of cabin 100 can be configured to attach to the motion platform. Attachment points 170 on the bottom 170 of cabin 100 can be configured to receive fasteners or engage with other attachment mechanisms. Attachment points 170 can take a variety of forms to work with the various attachment mechanisms described above.

Variations are contemplated in which cabin 100 includes more or fewer walls, no walls, one or more openings in various walls, more or fewer seats, different types of seats, different relative heights of walls or seats, and other variations. As an example, in some embodiments, cabin 100 can be a gondola comprising windows for passengers. In some embodiments, the seats 120A-C, as shown, can be configured differently to be a support that receives an attachment of a separate seat (e.g., a bucket seat, seat cushion, bench, backrest, or others) where the separate seat is not part of the monocoque body. As another example, cabin 100 can include an integral railing in place of one or more walls.

Physical components may be added to the cabin such as to provide a canopy, lights, speakers, or other elements to enhance the experience. Such components may be additions (not part of the monocoque body) and therefore, add weight or contribute other factors that the monocoque body is configured to also support (in combination with passengers) when in use. The monocoque body can include features to receive or otherwise engage with such additional components. For example, the monocoque body can include cavities configured to receive lights, speakers, screens, etc.

The monocoque body alone provides all of the structural support for the operation of the cabin 100 or provides most of the structural support. The cabin 100 can be constructed using a primary laminate construction using a single mold that as a result of the operation produces the monocoque body or as an assembly in which physical parts are formed using primary laminate construction and assembled using secondary bonding that as a result of the operation produces the monocoque body. The created monocoque passenger cabin is a one-piece structural shell made of fiber reinforced sheet.

Disclosed embodiments further include an amusement park ride including a cabin (e.g., cabin 100 having a monocoque body). Amusement rides can include rides having an enclosed or partially enclosed cabin. Such rides can include (but are not limited to) rollercoasters, Ferris wheels, ski lifts/gondolas, flight simulators, driving simulators, children's theme rides, and other styles of amusement park/carnival style rides.

The term “sheet” should be understood to include one or more layers. The layers or material in layer can be adhered together by way of a polymer. For clarification, the term “sheet” also derives from the general techniques for the additive application of carbon fiber construction but should not necessarily be limited to those techniques.

The foregoing merely illustrates the principles of the disclosure. Any examples set forth in this specification are not intended to be limiting and merely set forth some of the many possible embodiments for the appended claims. Those skilled in the art will readily recognize various modifications and changes that may be made without following the example embodiments and applications illustrated and described herein, and without departing from the true spirit and scope of the following claims.

What is claimed is:

1. A monocoque passenger cabin for an amusement ride device comprising:
a monocoque body comprising:
a wall,
a floor, and
a first seat portion;
wherein the wall and the first seat portion each extend from and are integral to the floor.

2. The cabin of claim 1, wherein the wall comprises an opening configured to allow passengers to enter and exit the cabin.

3. The cabin of claim 1, further comprising a second seat portion.

4. The cabin of claim 3, wherein the first and second seat portions are arranged facing the same direction.

5. The cabin of claim 3, wherein the first and second seat portions are arranged facing the opposite direction.

6. The cabin of claim 5, wherein the first and second seat portions are arranged to face each other.

7. The cabin of claim 5, wherein the first and second seat portions are arranged to face away from each other.

8. The cabin of claim 3, further comprising a third seat portion.

9. The cabin of claim 8, wherein the first, second, and third seat portions are arranged in a row.

10. The cabin of claim 3, wherein the floor comprises a plurality of levels.

11. The cabin of claim 10, wherein:
the first seat portion is positioned on a first level of the plurality of levels; and
the second seat portion is positioned on a second level of the plurality of levels.

12. The cabin of claim 11, wherein the first level is lower than the second level.

13. The cabin of claim 1, further comprising an aisle configured to permit movement by one or more passengers within the cabin.

14. The cabin of claim 13, wherein:
the wall comprises an opening configured to allow passengers to enter and exit the cabin; and
the opening is positioned on a portion of the wall adjacent to the aisle.

15. The cabin of claim 1, wherein the floor, wall, and seat portion are integrally constructed as a one-piece structural shell made of fiber reinforced sheet.

16. The cabin of claim 15, wherein the fiber reinforced sheet comprises at least one of:
one or more polymer skins reinforced with carbon fiber; or
a fiber reinforced multilayer epoxy bound sheet.

17. The cabin of claim 16, wherein the fiber reinforced sheet further comprises a foam or honeycomb core.

18. The cabin of claim 1, wherein the cabin is constructed at least partially using a three-dimensional printing process.

19. The cabin of claim 1, wherein a bottom portion of the floor is configured to attach to a motion platform.

20. An amusement park ride comprising the cabin of claim 1.
